(19) United States
(12) Patent Application Publication
(10) Pub. No.: US 2023/0004883 A1
(43) Pub. Date: Jan. 5, 2023

(54) Interactive Stochastic Design Tool

(71) Applicant: Applied Underwriters, Inc., Omaha, NE (US)

(72) Inventor: Justin N. Smith, Woodside, CA (US)

(21) Appl. No.: 17/784,626

(22) PCT Filed: Dec. 11, 2020
(86) PCT No.: PCT/US20/64419

§ 371 Date: Jun. 10, 2022

Related U.S. Application Data
(60) Provisional application No. 62/947,021, filed on Dec. 12, 2019.

(51) Int. Cl. G06Q 10/06; G06Q 40/06; G06Q 50/02

(52) U.S. Cl. CPC G06Q 10/067; G06Q 40/06; G06Q 50/02

(57) ABSTRACT

An interactive stochastic design tool has an input device, an output device, and a digital processor. The digital processor reads in initiation data describing a stochastic process and a threshold boundary. It then computes one or more realizations of the stochastic process. The realizations and the threshold boundary are displayed on the output device. The user may then input an indication to enforce the threshold boundary. The processor then redisplays the realizations that do not cross the enforced threshold boundary.

### CROSS-REFERENCE TO RELATED APPLICATIONS)

This application is a US National Phase entry for International Application No. PCT/US20/64419, titled “INTERACTIVE STOCHASTIC DESIGN TOOL” filed on Dec. 11, 2020, which claims the benefit of, and priority to, U.S. Provisional Application No. 62/947,021, titled “INTERACTIVE STOCHASTIC DESIGN TOOL” filed on Dec. 12, 2019, the entire specifications of which are incorporated herein by reference.

### BACKGROUND OF THE INVENTION

### Technical Field

The inventions described herein are in the field of stochastic design tools.

### Background Art

There is a long felt need for interactive tools to facilitate the design of stochastic processes.

### BRIEF DESCRIPTION OF DRAWINGS:

FIG. 1 illustrates a practical application of a stochastic process.

FIG. 2 is a graph of alternative realizations of a stochastic process.

FIG. 3 is a schematic of an interactive stochastic design tool.

FIG. 4 is a flow chart of a method for providing an interactive stochastic design tool.

FIG. 5 is a graphical user interface of an interactive stochastic design tool.

FIG. 6 is a graphical user interface of an interactive stochastic design tool with enforceable threshold boundaries.

FIG. 7 is a graphical user interface of the interactive stochastic design tool of FIG. 6 with a first threshold boundary enforced.

FIG. 8 is a graphical user interface of the interactive stochastic design tool of FIG. 6 with a second threshold boundary enforced.

### DETAILED DESCRIPTION

The disclosure of invention is provided as a guide to understanding the invention. It does not necessarily describe the most generic embodiment of the invention or the broadest range of alternative embodiments.

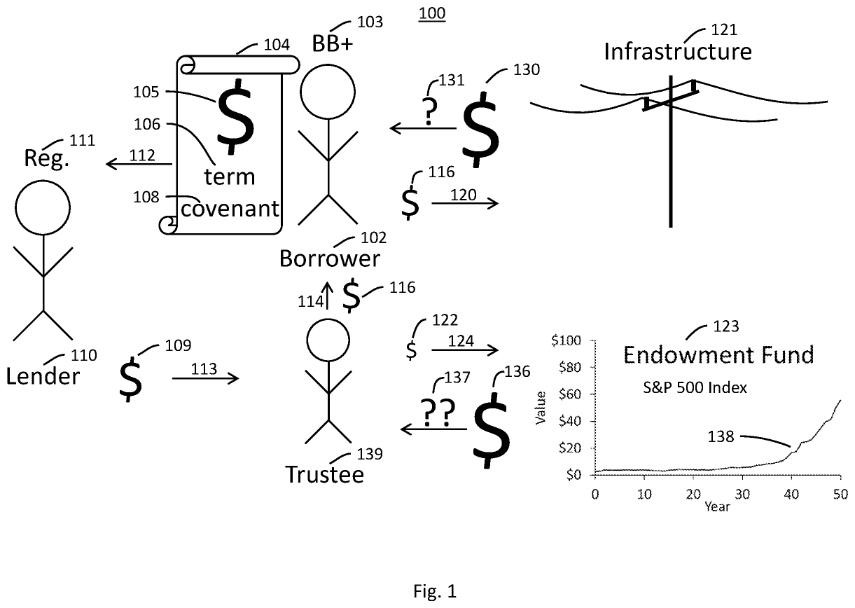

FIG. 1 illustrates a practical application 100 of a stochastic process. The practical application is the provision of a zero-coupon bond 104 with a companion endowment fund 123. The bond may comprise a face value 105, a term 106, and other covenants 108. The covenants may be memorialized in an offering memorandum. The bond is provided 112 by a borrower 102 to a lender 110 in exchange 113 for proceeds 109. The borrower may be characterized by a likelihood of default 103. Examples of a likelihood of default include a numerical probability of default, or a credit rating.

The lender may be constrained by certain regulations 111. A lender that is a pension fund, for example, may be constrained to invest in relatively safe investments, such as bonds.

The proceeds 109 from the bond may be initially transferred to a trustee 139. The trustee may divide the proceeds into a first portion 116 and a second portion 122. The first portion of the proceeds may be transferred 114 to the borrower. The borrower may allocate 120 the first portion of the proceeds to a first use 121. For example, if the borrower is a sovereign entity, such as Bangladesh, the first use may be an investment in said sovereign entity's infrastructure, such as its electric grid. The investment in infrastructure may yield benefits to the sovereign entity, such as an improved economy, an increased tax base and/or fees collected for use of the infrastructure (e.g., tolls). These benefits may yield funds 130 that can pay back the bond upon its maturity at its term.

There is some uncertainty 131, however, on whether or not the proceeds allocated to the first use will produce enough funds for the borrower to pay back the face value of the bond. To protect against that, the second portion 122 of the proceeds may be allocated 124 by the trustee 139 to a second use, such as an endowment fund 123. The endowment fund may be independently managed by the trustee. The second use may be designed to also produce funds 136 to repay the face value of the bond upon maturity. If the endowment fund needs a higher yield than the first use, then the uncertainty 137 in producing enough funds 136 to repay the face value of the bond may be higher than the uncertainty 131 of the first use.

The funds that may be available from the first use can be described by a first stochastic process over the term of the bond. If the funds are allocated to an infrastructure project, for example, there are uncertainties as to timely completion of the project, impact on the economy, impact of weather (e.g., typhoons), revenue collected, etc.

100181 The funds that may be available from the second use can be described by a second stochastic process 138. For example, if the second use is an endowment fund, such as an S&P 500 Index fund, then there are uncertainties as to the drift of the fund and the volatility of the fund over the term of the bond. An interactive stochastic design tool, therefore, is needed to design these stochastic processes.

The interactive stochastic design tool will be described herein with respect to the second stochastic process. The tool, however, can be applied to any stochastic process including the first stochastic process, or the combination of the first and second stochastic process.

The interactive stochastic design tool can be used for physical stochastic processes. For example, the second use may be a tree plantation where the growth of the trees over a multi-year period is subject to uncertainties, such as weather. The second stochastic process, therefore, would model the growth of the trees.

The second stochastic process can also include the impact of price fluctuations. Hence the second stochastic process can integrate both physical and financial processes.

### Stochastic Processes

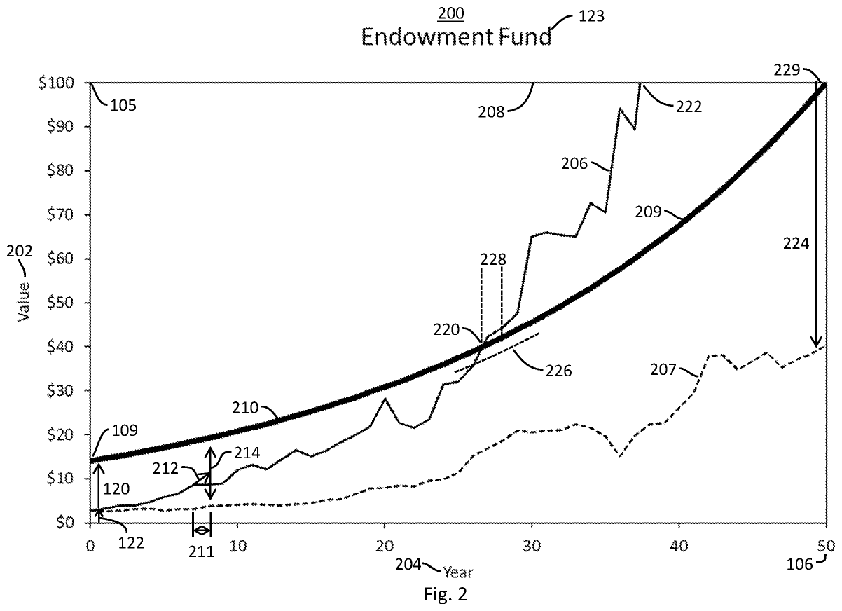

FIG. 2 is a graph 200 of alternative realizations of a second stochastic process, such as an endowment fund 123. The graph shows fund value 202 as a Y axis versus time 204 as an X axis. A first realization 206 and a second realization 207 of the stochastic process are shown. Each realization has the same initial conditions. The path a given realization takes is a function of a selection of one or more random values used to calculate the values of said realization.

The realizations in this example are computed using a random walk model. Any model appropriate to the stochastic process may be used. Alternative models, for example, my include a random walk with a uniform variance or a random walk with a heterogeneous variance.

Each realization has an initial value equal to the proceeds 122 allocated to the second use. The random walk for each subsequent time step 211 is computed by multiplying value of the random walk at the beginning of the time step by a factor equal to e raised to the power of a drift 212 plus a random offset 214. Thus, if the drift is 0.04 and a randomly selected offset is −0.05, then the factor is equal to e^{(0.04-0.05)}=0.99. Hence the next value of the random walk for this time step will be lower than the initial value for this time step.

Any random method appropriate to the stochastic process can be used to calculate subsequent values of the random walk.

The distribution of the random offsets can be any distribution appropriate to the stochastic process. For an endowment fund based on the S&P 500 Index, for example, appropriate distributions include a lognormal distribution, a Pareto distribution, or other long-tailed distributions. In the examples provided herein, the random offsets are described by a lognormal distribution with a mean of zero. In FIG. 2, the realizations were calculated using an annualized standard deviation of 0.1 and a lognormal distribution.

In practice, the values for the drift for a given fund can be computed based on prior performance of the fund. The S&P 500 Index, for example, was initiated in 1950. Thus, values of the S&P 500 from initiation to the present can be used to determine values of drift and volatility (e.g., standard deviation) to be used in computing realizations thereof. More sophisticated models and expert judgement can also be used to forecast the drift and volatility of the fund over the term of the bond.

### Threshold Boundaries

Graph 200 also shows a first threshold boundary 208 and a second threshold boundary 209. The threshold boundaries have a practical utility in improving the performance of the computer-based interactive stochastic design tool. As described below, a user, such as a designer of a stochastic process, can enforce the threshold boundaries in order to determine the expected performance of stochastic process under different boundary conditions. This reduces the number of realizations that have to be calculated and hence improves the performance of the computer performing the calculations.

The first threshold boundary 208 has a constant value equal to the face value 105 of the bond. If a realization of the performance of the endowment fund crosses 222 the first threshold boundary during the term 106 of the bond, then one of the covenants of the bond may be to allow the lender to redeem the bond for its face value. From the lender's perspective, an early redemption means that the lender has earned a higher-than-expected rate of return on the bond. From the borrower's perspective, the future obligation to pay the bond is also relieved. Furthermore, there is no requirement to use any of the funds 130 (FIG. 1) realized from the first use 121 (FIG. 1). Thus, when looking at overall impacts of design parameters on the range of outcomes of the stochastic process, a designer may wish to remove (e.g., filter) all realizations that cross the first threshold boundary and then recompute the expected remaining shortfalls of the endowment fund to repay the face value of the bond at maturity.

The second threshold boundary 209 has an initial value at the total proceeds 109 of the bond. The total proceeds are equal to the proceeds 120 allocated to the first use plus the proceeds 122 allocated to the second use plus any expenses. Hence the initial value of the second threshold boundary is between the initial value of the realizations of the stochastic process and the initial value of the first threshold boundary.

(00311 The second threshold boundary then grows exponentially 210 to a final value 229 at the term 106 of the bond. The final value is equal to the face value 105 of the bond. The threshold boundary, therefore, represents a line of constant yield for the bond. If a realization of the stochastic process crosses 220 the second threshold boundary, then the lender may want the option of redeeming the bond for the yield value at that time. A lender might wish to do this, for example, if the expected default rate of the borrower has gone up since the inception of the bond. Conversely, the borrower may wish to call the bond if its expected default rate has gone down since the inception of the bond and the borrower can now secure funds at a lower rate. Thus, a designer may wish to remove the realizations that cross the second threshold boundary and examine the statistics of the shortfalls 224 of the realizations 207 that remain.

Any number of other threshold boundaries may be provided in order to facilitate examining the impact of other design features on the stochastic process. For example, a “liquidation boundary” 226 may be provided somewhat below either the first threshold boundary or the second threshold boundary. The liquidation boundary would provide for at least a partial liquidation of the endowment fund prior to the value of the fund crossing the first or second threshold boundary. This would allow the trustee to unwind the fund's position without unduly impacting the market. The cost of this early unwinding can be factored into the bond expenses.

A “price guarantee window boundary” 228 may also be provided. The price guarantee window is a guarantee that the endowment fund will receive the price that was available when the value of the fund crossed 220 a threshold boundary even though there may be movement of the fund in the time window it takes to unwind the fund's position. By enforcing this threshold boundary, a designer can determine the expected costs of providing the price guarantee window.

### Interactive Stochastic Design Tool

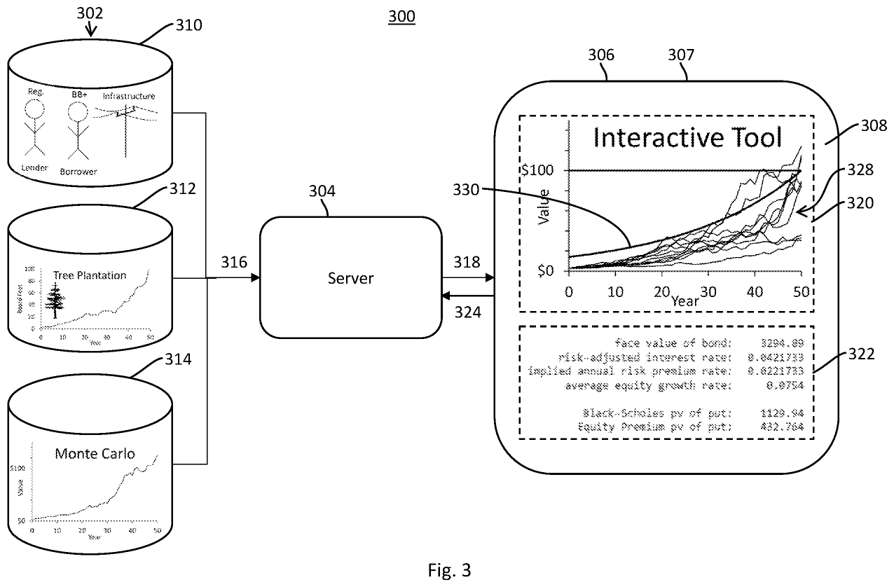

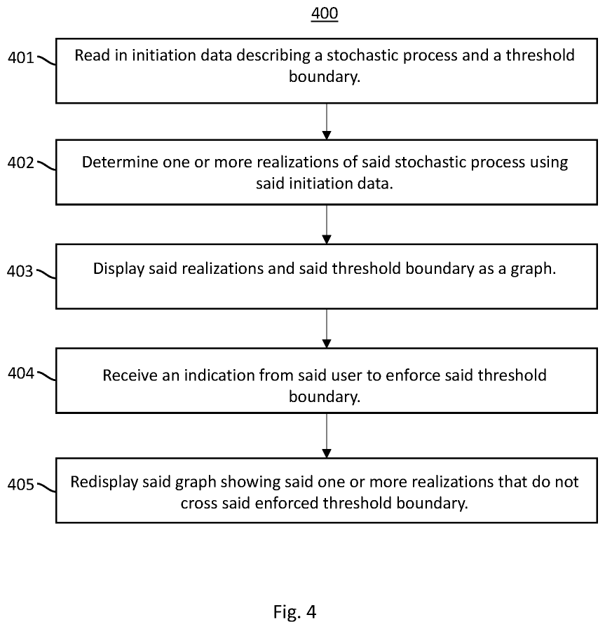

FIG. 3 is a schematic of a computer-based interactive stochastic design tool 300. FIG. 4 is a flow chart of a method 400 for providing said computer-based interactive stochastic design tool.

Referring to FIGS. 3 and 4, the tool comprises:

an input device 306 (e.g., a touch screen 308) adapted to receive input from a user;

an output device 307 (e.g., said same touch screen 308) adapted to provide graphical output 320 to said user;

a digital processor (e.g., a server 304); and

a permanent memory (e.g., one or more databases 302) comprising computer readable instructions operable to cause said digital processor to carry out the steps 400:

read in 316, 401 initiation data describing a stochastic process and a threshold boundary;

determine 402 one or more realizations of said stochastic process using said initiation data;

display 318, 403, by said output device, said one or more realizations 328 and said threshold boundary 330 as a graph;

receive 324, 404, by said input device, an indication from said user to enforce said threshold boundary; and

redisplay 405, by said output device, said graph showing said one or more realizations that do not cross said enforced threshold boundary.

The permanent memory 302 may comprise one or more of:

a database 310 comprising data describing the bond and the parties to the bond;

a database 312 comprising data describing one or more alternative endowment funds (e.g., a tree plantation); and

a database 314 comprising one or more stochastic models useful for simulating the performance of the endowment fund. The stochastic models may include Monte Carlo models that compute individual realizations, or analytic models, such as a Black-Scholes model, that computes aggregate realizations.

The tool may also be adapted to provide numerical output 322 of the expected bond performance and other calculated characteristics.

### BEST MODE FOR CARRYING OUT THE INVENTION

The detailed description describes non-limiting exemplary embodiments. Any individual features may be combined with other features as required by different applications for at least the benefits described herein. As used herein, the term “about” means plus or minus 10% of a given value unless specifically indicated otherwise.

A portion of the disclosure of this patent document contains material to which a claim for copyright is made. The copyright owner has no objection to the facsimile reproduction by anyone of the patent document or the patent disclosure, as it appears in the Patent and Trademark Office patent file or records but reserves all other copyright rights whatsoever.

As used herein, a “computer-based system” comprises an input device for receiving data, an output device for outputting data in tangible form (e.g., printing or displaying on a computer screen), a permanent digital memory for storing data, computer code and other digital instructions, and a digital processor for executing digital instructions wherein said digital instructions resident in said permanent memory will physically cause said digital processor to read-in data via said input device, process said data within said processor and output said processed data via said output device. The digital processor may be a microprocessor. All computer-based systems described herein may refer to singular components (e.g., a work station) or distributed components (e.g., cloud-based computing).

As used herein, equations or formulas represent statements of methods for performing calculations.

As used herein, the term “shaped” means that an item has the overall appearance of a given shape even if there are minor variations from the pure form of said given shape.

As used herein, the term “generally” when referring to a shape means that an ordinary observer will perceive that an object has said shape even if there are minor variations from said shape.

As used herein, relative orientation terms, such as “up”, “down”, “top”, “bottom”, “left”, “right”, “vertical”, “horizontal”, “distal” and “proximal” are defined with respect to an initial presentation of an object and will continue to refer to the same portion of an object even if the object is subsequently presented with an alternative orientation, unless otherwise noted.

### Graphical User Interface

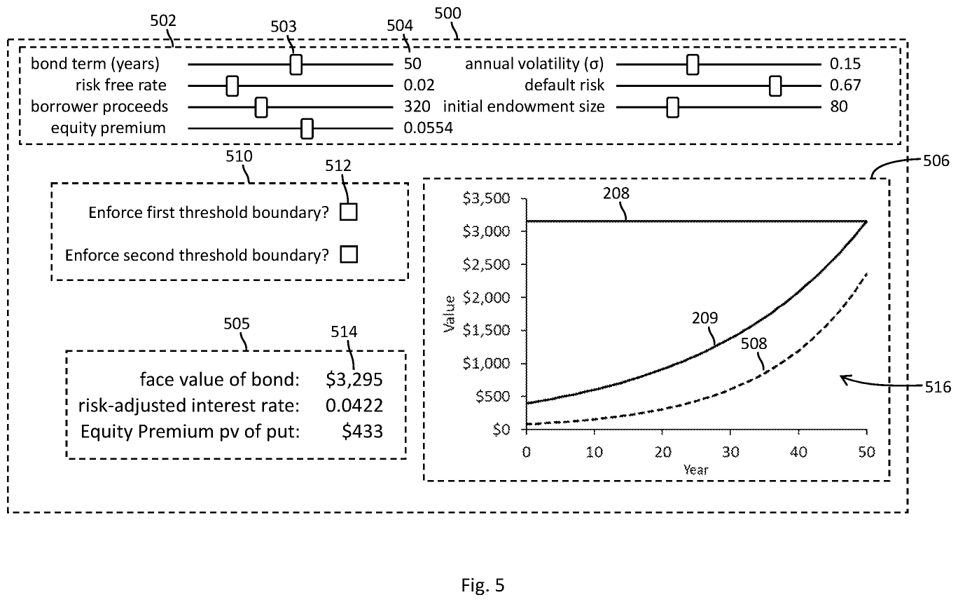

FIG. 5 is a graphical user interface 500 of an interactive stochastic design tool. The graphical user interface may be displayed on an output device, such as a touch screen. The graphical user interface may comprise:
a) a user input field 502;
b) a threshold boundary user input field 510;
c) a numerical output field 505; and
d) a graphical output field 506.

As used herein, fields of a graphical user interface are defined for ease of explanation. Fields may be arranged in any manner and may overlap. Portions of the numerical output field 505, for example, may be displayed within the graphical output field 506.

The user input field 502 may comprise:
a) one or more analog input fields 503, such as a slide bar; and
b) one or more alphanumeric input fields 504 where a user may type in a particular desired value for a parameter.

An advantage of an analog input field is that a user may vary input in a continuous manner and, in real time, see the effects of said varied input on the output fields 505, 506. An advantage of an alphanumeric input field is that the user can type in an exact desired value. If an analog input field and an alphanumeric input field are provided for the same parameter (e.g., “bond term (years)”), then the field receiving the most recent user input may take priority.

The threshold boundary enforcement user input field 510 may comprise a selection input field 512 for each selectable threshold boundary.

The numerical output field 505 may provide calculated values 514 of various design parameters and other characteristics of a stochastic process based on the user input. The output fields may be updated in real time depending upon the calculation requirements of the models for the stochastic process and the speed of computation of the digital processor.

The graphical output field 506, may comprise a graph 516. The graph may comprise one or more threshold boundaries 208, 209 and one or more realizations 508 of the stochastic process.

As used herein, a realization may comprise one or more of an individual realization or an aggregate realization. An example of an individual realization is a random walk. An example of an aggregate realization is the output of a Black-Scholes model. An aggregate realization may be an estimate of an average of individual realizations. Aggregate realizations may also include upper and lower bounds for the expected deviations of individual realizations from the average realization. A suitable upper and lower bound is plus or minus 1 or 2 standard deviations from the average.

An advantage of displaying aggregate realizations is that the computation time is often short. Thus, slower processors can nonetheless display in real time the changes in realizations in response to variations in user input.

An advantage of individual realizations is that the user can see the paths of each individual realization and hence see particular behaviors. These particular behaviors might include an individual realization crossing back and forth across a threshold boundary.

The graphical output field 506 may display a sampling of individual realizations used to calculate the numerical output. For example, 100,000 random walks might be calculated in order to determine the values of the numerical output with adequate accuracy. A sample of 10 to 1,000 of the 100,000 random walks may be displayed in the graph so that collective behavior of the random walks as a whole can be seen as well individual behaviors. The displayed random walks may be selected by analytic methods (e.g., every 100th random walk) or stochastic methods (e.g., 100 random walks randomly selected from the 100,000). Experiment has shown that displaying 10 to 1,000 random walks is effective at giving a user a good sense for how the stochastic process might perform.

Line weights and color of the realizations may be varied depending upon user requirements. For example, the colors of the realizations may be varied in accordance with the threshold boundaries that are selected. This will give a user an intuitive feel for which threshold boundaries are enforced when viewing a graph.

### Enforced Threshold Boundaries

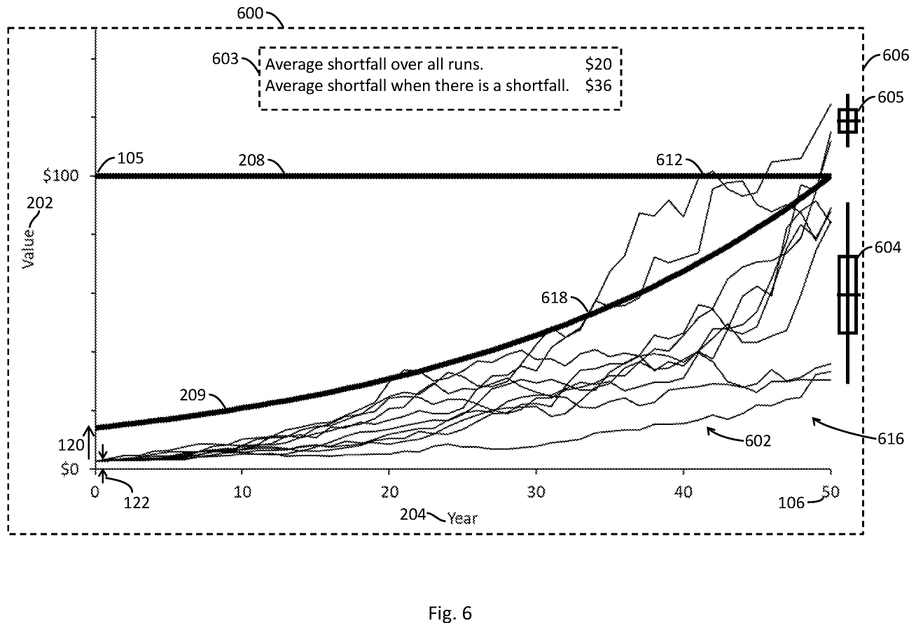

FIG. 6 is a graphical user interface 600 of an interactive stochastic design tool with enforceable threshold boundaries. A graphical output field 606 is shown. The graphical output field may comprise a graph 616 and a numerical output field 603.
a) The graph may comprise:
b) a Y axis 202 of fund value;
c) an X axis 204 of time;
d) a plurality 602 of individual realizations;
e) a first threshold boundary 208;
f) a second threshold boundary 209; and
g) one or more box plots 604, 605.

As described above, the first threshold boundary 208 may have a constant value equal to the face value 105 of a bond.

The second threshold boundary 209 may have an initial value equal to the sum of the first 120 and second 122 proceeds of the bond. The initial value may also include applicable expenses of the bond. Expenses are ignored herein for the sake of simplicity of explanation, but they can nonetheless be taken into account. Expenses may be particularly important for certain candidate endowment funds, such as managed funds, that strive to get higher than average returns.

The second threshold boundary 209 may have a final value at the term 106 of the bond equal to the face value 105 of the bond. The second threshold boundary may grow exponentially between said initial value and said final value at a rate defined as the yield of the bond.

The box plots 604, 605 are graphical indications of the distribution of final values of the individual realizations at the term 106 of the bond. Any graphical indication of a distribution may be used, such as a bell curve. The graphical indication may be based on the computation of a large number (e.g., 100,000) individual realizations and not necessarily based solely on the displayed individual realizations.

The graphical indications may also be based on analytic methods for determining the distribution of outcomes, such as a Black-Scholes model.

The first box plot 605 indicates the distribution of individual realizations that exceed the face value of the bond at its term. The second box plot 604 indicates the distribution of individual realizations that are less than the face value of the bond at its term. Box plots can be defined in any manner suitable to the stochastic process being modeled. Box plots for a tree plantation, for example, may take into account yields of processing the trees depending upon their final use (e.g., lumber, pulp, veneers, etc.).

A user can see that some of the realizations cross 612 the first threshold boundary and some cross 618 the second threshold boundary before the end of the term of the bond. The user may then enforce the first or second threshold boundary to see what impact that might have on the average expected shortfall over all runs or the average expected shortfall when there is a shortfall as shown in the numerical output field 603. This will help the user determine if calling the bonds when either the first or second threshold is reached should be required, optional, or not allowed.

In this example, the numerical output field 603 displays an average shortfall over all runs of $20. It displays an average shortfall when there is a shortfall of $36. The average shortfall over all runs assumes that the borrower will not have to pay off the bonds when the endowment fund crosses the first threshold boundary. The borrower then reaps on average the profit 605 of the realizations that exceed the face value of the bond. This reduces the average expected shortfall but may make the bonds less desirable. One of the attractive features of a bond with a companion endowment fund is that it gives lenders a chance to earn higher than expected returns if the endowment fund should cross the first threshold boundary before the end of the term of the bond. This is a further motivation for the user to view the impact of enforcing the first threshold boundary.

The average shortfall when there is a shortfall also indicates to the user the impact of enforcing the first threshold boundary.

### Enforcing the First Threshold Boundary

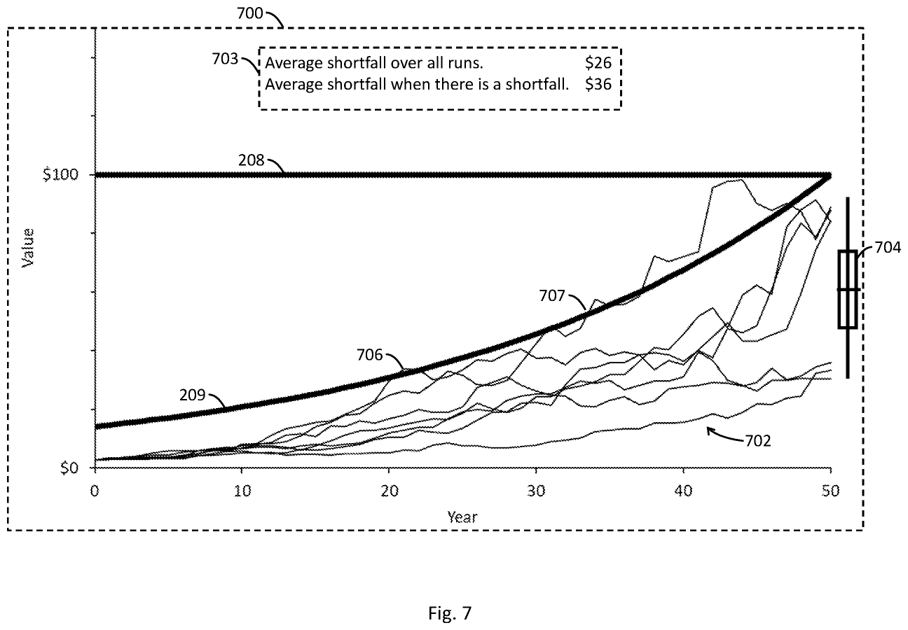

FIG. 7 is a graphical user interface 700 of the interactive stochastic design tool of FIG. 6 with the first threshold boundary 208 enforced. The only realizations 702 that are displayed are those that do not cross the first threshold boundary. The boxplot 704 of the realizations that have a shortfall is the same in this example as the boxplot 604 in FIG. 6. If one of the realizations had exceeded the first threshold boundary and then came down for a final value at the term of the bond that was less than the face value of the bond, then the box plot and the computed shortfalls in the numerical output field 703 would be different than the examples in FIG. 6 since the realization that crossed and then came down would have been eliminated and would no longer contribute to the average shortfall at the end of the term. Showing a higher number of realizations, such as 100, would more likely reveal examples of realizations that cross the first threshold boundary but then return below by the end of the term of the bond.

Some of the realizations cross 706, 707 the second threshold boundary 209. All of these realizations return below the second threshold boundary before the end of the term of the bond. This is a consequence of the first and second threshold boundaries joining at the end of the term of the bond. Any realization that did not return below the second threshold boundary would also have exceeded the first threshold boundary and hence would not be shown. The impact of these returning realizations can be determined by enforcing the second threshold boundary.

### Enforcing the Second Threshold Boundary

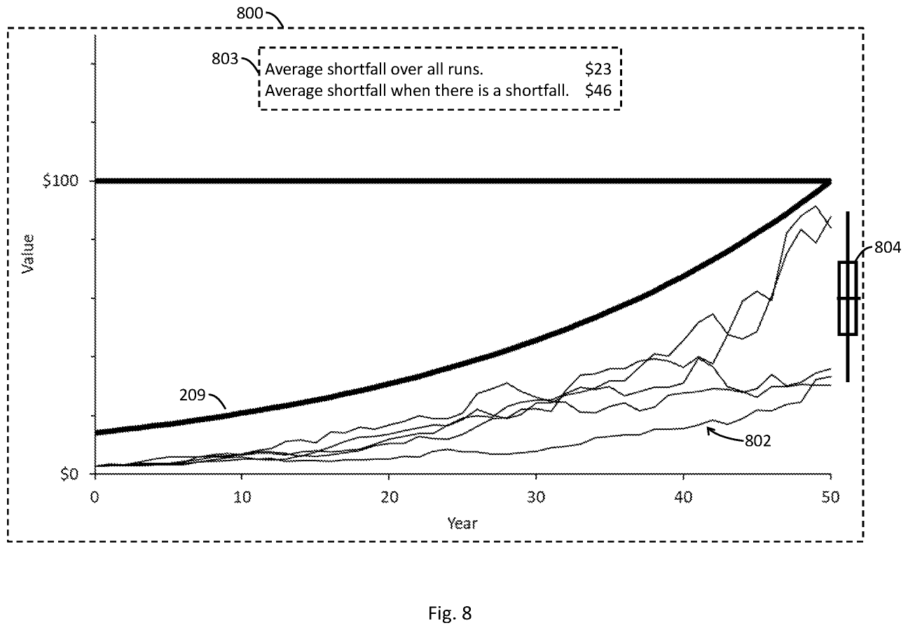

FIG. 8 is a graphical user interface 800 of the interactive stochastic design tool of FIG. 6 with the second threshold boundary 209 enforced. None of the displayed realizations 802 intersect the second threshold boundary. The box plot 804, has now changed as well as the computed average shortfalls in the numerical output field 803. Compared to FIG. 7, the average shortfall over all runs has come down. This is due to the fact that more bonds would have been paid off early. The average shortfall when there is a shortfall, however, is larger since realizations that do not cross the second threshold boundary at all are more likely to be lower than realizations that do cross the second threshold boundary at least once. Thus, the user can make the tradeoff of a lower probability of having to make a higher payoff if the bonds are structured to require or allow redemption or calling if the endowment fund intersects the second threshold boundary.

While the disclosure has been described with reference to one or more different exemplary embodiments, it will be understood by those skilled in the art that various changes may be made, and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

What is claimed is:

1. An interactive stochastic design tool comprising:
a) an input device adapted to receive input from a user;
b) an output device adapted to provide graphical output to said user;
c) a digital processor; and
d) a permanent memory comprising computer readable instructions operable to cause said digital processor to carry out the steps:
i) read in initiation data describing a stochastic process and a threshold boundary;
ii) determine one or more realizations of said stochastic process using said initiation data;
iii) display, by said output device, said one or more realizations and said threshold boundary as a graph;
iv) receive, by said input device, an indication from said user to enforce said threshold boundary; and
v) redisplay, by said output device, said graph showing said one or more realizations that do not cross said enforced threshold boundary.

2. The interactive stochastic design tool of claim 1 wherein said stochastic process is one or more of:
a) an agricultural process; or
b) a financial process.

3. The interactive stochastic design tool of claim 1 wherein:
a) said initiation data comprises a first threshold boundary and a second threshold boundary;
b) said first threshold boundary has a constant value over time up to a term;
c) said second threshold boundary:
i) has an initial value that is:
1) greater than an initial value of said stochastic process; and
2) less than said value of said first threshold boundary;
ii) has a final value at said term about equal to said value of said first threshold boundary; and
iii) grows exponentially over time at a yield rate; and
d) said computer readable instructions are operable to cause said digital processor to carry out the steps:
i) display, by said output device, said first and second threshold boundaries in said graph;
ii) receive, by said input device, an indication, from said user, to enforce one or more of said first threshold boundary or said second threshold boundary; and
iii) redisplay, by said output device, said one or more realizations that do not cross said enforced threshold boundaries.

4. The interactive stochastic design tool of claim 3 wherein said computer readable instructions are operable to cause said digital processor to carry out the steps:
a) determine an average value, at said term, of said realizations that do not cross said enforced threshold boundaries; and
b) display, by said output device, said average value.

5. The interactive stochastic design tool of claim 1 wherein said computer readable instructions are operable to cause said digital processor to carry out the steps:
a) display, by said output device, one or more input fields for one or more of said data in said initiation data; and
b) receive, by said input device, said one or more of said data in said initiation data provided by said user in said input fields.

6. The interactive stochastic design tool of claim 1 wherein said initiation data comprises:
a) an initial value of said stochastic process;
b) a time step of said stochastic process;
c) a drift of said stochastic process over said time step;
d) a volatility of said stochastic process over said time step;
e) a term of said stochastic process; and
f) data describing said threshold boundary.

7. The interactive stochastic design tool of claim 1 wherein said one or more realizations comprises an individual realization or an aggregate realization.
